(19) United States
(12) Patent Application Publication
(10) Pub. No.: US 2026/0186216 A1
(43) Pub. Date: Jul. 2, 2026

(54) ELECTRONIC PACKAGE

(71) Applicant: SILICONWARE PRECISION INDUSTRIES CO., LTD., Taichung City (TW)

(72) Inventors: Chung-Yu KE, Taichung City (TW); Bo-Hung HUANG, Taichung City (TW); Kun-Sheng TSAI, Taichung City (TW); Liang-Pin CHEN, Taichung City (TW)

(73) Assignee: SILICONWARE PRECISION INDUSTRIES CO., LTD., Taichung City (TW)

(21) Appl. No.: 19/434,810

(22) Filed: Dec. 29, 2025

(30) Foreign Application Priority Data
Jan. 2, 2025 (TW) 114100143

(51) Int. Cl. G02B 6/42

(52) U.S. Cl. CPC G02B 6/423

(57) ABSTRACT

An electronic package is provided and includes a carrier structure, a photonic component disposed on the carrier structure, and an optical communication unit connected to the photonic component. The photonic component has first alignment structures on a side corresponding to the optical communication unit, and the optical communication unit has second alignment structures on a side corresponding to the photonic component. Through engagement of the first alignment structures and the second alignment structures, the photonic component and the optical communication unit can be precisely connected to each other.

### BACKGROUND

### 1. Technical Field

The present disclosure relates to a semiconductor device, and more particularly, to an electronic package having a photonic component.

### 2. Description of Related Art

With the rapid development of the electronics industry, electronic products are gradually moving toward multifunctionality and high performance. Currently, the application of fifth-generation (5G) communication technology has expanded into fields such as the Internet of Things (IoT), Industrial Internet of Things (IIoT), cloud computing, artificial intelligence (AI), autonomous vehicles, and medical devices. As these application domains grow, enormous volumes of data require efficient transmission, processing, and storage. Therefore, the demand for data transmission from large data centers and cloud servers has surged in recent years, prompting industry to replace electrical signals with light as the carrier. Against this backdrop, co-packaged optics (CPO) structures have emerged as a future trend in the development of semiconductor and packaging technologies.

In a conventional CPO structure, an electronic integrated circuit (EIC) component and a photonic integrated circuit (PIC) component are disposed on a substrate. One end of the PIC component is connected to a fiber array unit (FAU) for the installation and accommodation of optical fibers.

However, the alignment requirements between the FAU and the PIC component must be extremely precise. Otherwise, any deviation or misalignment between the FAU and the PIC component may result in signal loss during optical fiber transmission.

Therefore, how to overcome the aforementioned problems of the prior art has become an urgent issue to be resolved.

### SUMMARY

An electronic package according to the present disclosure is provided, and the electronic package comprises: a carrier structure; a photonic component disposed on the carrier structure; and an optical communication unit connected to the photonic component, wherein the photonic component has a first optical coupling surface on a side corresponding to the optical communication unit, first alignment structures are disposed on the first optical coupling surface, the optical communication unit has a second optical coupling surface on a side corresponding to the photonic component, second alignment structures are disposed on the second optical coupling surface, and the photonic component and the optical communication unit are connected to each other via the first alignment structures and the second alignment structures.

The aforementioned electronic package further comprises: an electronic component disposed on the carrier structure. The electronic component is an electronic integrated circuit chip. The photonic component is a photonic integrated circuit chip. The optical communication unit is a fiber array unit connected to the photonic component and accommodates optical fibers.

In the aforementioned electronic package, the first alignment structures and the second alignment structures are complementary concave-convex structures. The concave-convex structures are staggered and interlocked on the first optical coupling surface and the second optical coupling surface.

The aforementioned electronic package further comprises: an encapsulation layer formed on the carrier structure and encapsulating the photonic component.

In the aforementioned electronic package, the photonic component is connected to the optical communication unit via a coupling structure. The coupling structure is a light-transmissive structure. The coupling structure has a refractive index corresponding to both the photonic component and the optical communication unit. The coupling structure has the first optical coupling surface on a side corresponding to the optical communication unit.

In the aforementioned electronic package, the photonic component has coupling elements, and the coupling elements are exposed from a side surface of the photonic component and are respectively connected to first lenses. Each of optical fibers of the optical communication unit is provided with a second lens at an end corresponding to the photonic component. The first alignment structures and the second alignment structures become smaller in size the nearer the first alignment structures and the second alignment structures are to the second lenses.

The electronic package according to the present disclosure primarily features first alignment structures disposed on the first optical coupling surface of the photonic component, and second alignment structures disposed on the second optical coupling surface of the optical communication unit. This arrangement enables precise docking between the photonic component and the optical communication unit, effectively resolving the conventional misalignment issue that causes signal loss, and thereby enhancing the performance of silicon photonic transmission.

### BRIEF DESCRIPTION OF THE DRAWINGS

FIG. 1 is a schematic cross-sectional view of an electronic package according to a first embodiment of the present disclosure.

FIG. 2 is a schematic front view showing a connecting side of a photonic component and a connecting side of an optical communication unit in the electronic package according to the first embodiment of the present disclosure.

FIG. 3 is a schematic cross-sectional view of an electronic package according to a second embodiment of the present disclosure.

FIG. 4 is a schematic front view showing a connecting side of a photonic component and a connecting side of an optical communication unit in the electronic package according to the second embodiment of the present disclosure.

### DETAILED DESCRIPTION

The following describes the implementation of the present disclosure with examples. Those skilled in the art can easily understand other advantages and effects of the present disclosure from the contents disclosed in this specification.

It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable proposes should still be deemed as falling within the scope defined by the technical contents disclosed in the present specification. Meanwhile, terms such as “on,” “first,” “second,” “a,” “one,” “at least one,” and the like are merely used for clear explanation rather than limiting the practicable scope of the present disclosure, and thus, alterations or adjustments of the relative relationships thereof without essentially altering the technical contents should still be considered in the practicable scope of the present disclosure.

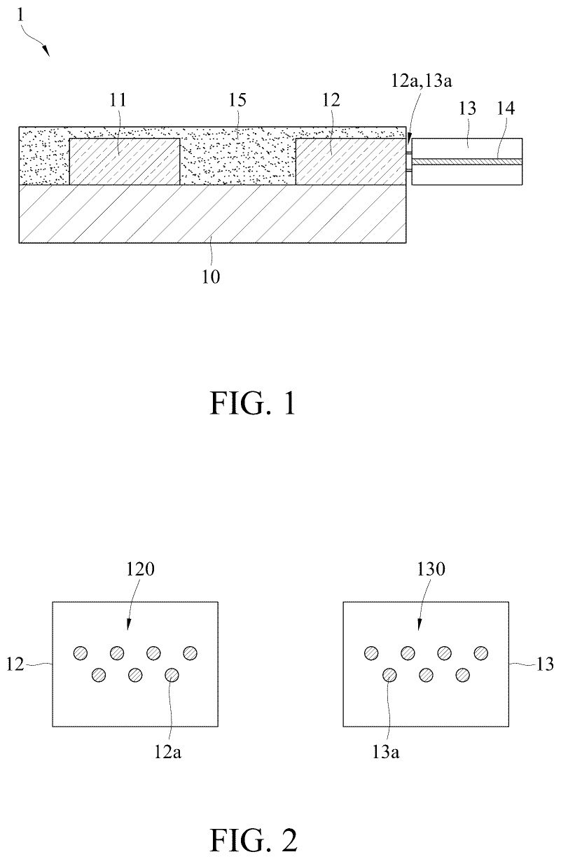

Please refer to FIG. 1, which is a schematic cross-sectional view of an electronic package 1 according to a first embodiment of the present disclosure. The electronic package 1 comprises a carrier structure 10, an electronic component 11 disposed on the carrier structure 10, a photonic component 12 disposed on the carrier structure 10, and an optical communication unit 13 connected to the photonic component 12.

The carrier structure 10 may be in the form of a packaging substrate. For example, the carrier structure 10 may be a packaging substrate having a core layer and a circuit structure, a coreless packaging substrate with a circuit structure, a through-silicon interposer (TSI) having conductive through-silicon vias (TSVs), or other types of boards. The carrier structure 10 includes at least one routing layer (wiring layer), such as at least one fan-out redistribution layer (RDL). It should be understood that the carrier structure 10 may also be other types of chip-supporting boards, such as a lead frame, a wafer, or other boards with metal routing, and is not limited to the examples described above.

The electronic component 11 is, for example, an electronic integrated circuit (EIC) chip. The electronic component 11 is disposed on the carrier structure 10 and is electrically connected to the carrier structure 10.

The photonic component 12 is, for example, a photonic integrated circuit (PIC) chip. The photonic component 12 is disposed on the carrier structure 10 and is electrically connected to the carrier structure 10.

The optical communication unit 13 is, for example, a fiber array unit (FAU). The optical communication unit 13 is connected to the photonic component 12 and accommodates optical fibers 14.

Please also refer to FIG. 2, which is a schematic front view showing a connecting side of the photonic component 12 and a connecting side of the optical communication unit 13 (in other words, FIG. 2 shows a connection interface between the photonic component 12 and the optical communication unit 13). In an embodiment, the photonic component 12 has a first optical coupling surface 120 on a side corresponding to the optical communication unit 13, and first alignment structures 12a are disposed on the first optical coupling surface 120. Conversely, the optical communication unit 13 has a second optical coupling surface 130 on a side corresponding to the photonic component 12, and second alignment structures 13a are disposed on the second optical coupling surface 130. The first alignment structures 12a and the second alignment structures 13a are, for example, complementary concave-convex structures, which can be staggered and interlocked on the first optical coupling surface 120 and the second optical coupling surface 130, such that the photonic component 12 and the optical communication unit 13 can be effectively connected via the mutual engagement of the first alignment structures 12a and the second alignment structures 13a.

In addition, the electronic package 1 further comprises an encapsulation layer 15 formed on the carrier structure 10 and encapsulating the electronic component 11 and the photonic component 12. The encapsulation layer 15 may be made of polyimide (PI), dry film, molding compound/colloid such as epoxy (epoxy resin), or other insulating materials. The encapsulation layer 15 may be formed on the carrier structure 10 via liquid compound dispensing, injection, lamination, compression molding, or other methods.

Accordingly, in the electronic package 1 according to the present disclosure, the first alignment structures 12a are disposed on the first optical coupling surface 120 of the photonic component 12, and the second alignment structures 13a are disposed on the second optical coupling surface 130 of the optical communication unit 13. Through the connection of the first alignment structures 12a and the second alignment structures 13a, the coupling accuracy between the optical regions of the photonic component 12 and the optical fibers 14 of the optical communication unit 13 can be enhanced, thereby improving the efficiency of optical signal transmission.

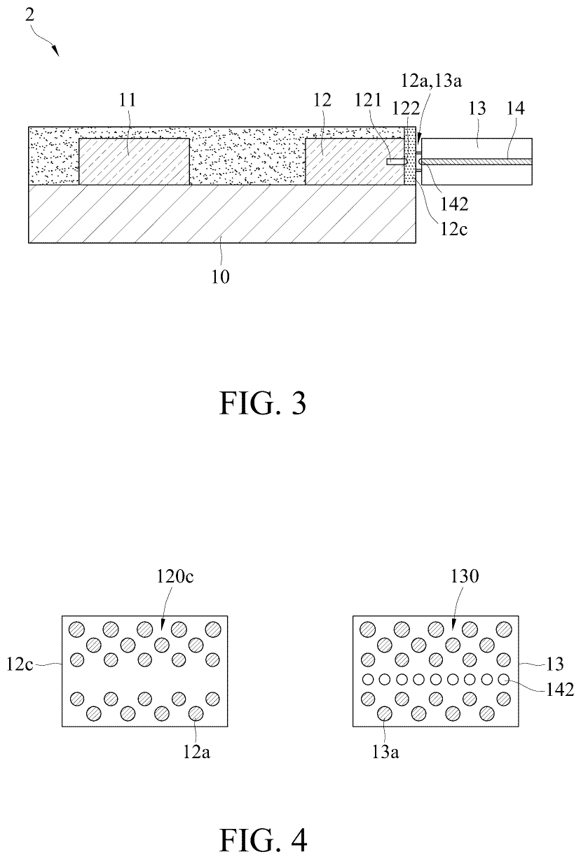

Please refer to FIG. 3, which is a schematic cross-sectional view of an electronic package 2 according to a second embodiment of the present disclosure.

The electronic package 2 of the second embodiment is generally similar to the first embodiment, with the primary difference being that the photonic component 12 may be connected to the optical communication unit 13 via a coupling structure 12c.

The coupling structure 12c is a light-transmissive structure (for example, made of a transparent colloid/compound/resin). The coupling structure 12c is disposed on a lateral side of the photonic component 12 to connect to the optical communication unit 13. The coupling structure 12c has a refractive index corresponding to both the photonic component 12 and the optical communication unit 13.

Please also refer to FIG. 4, which is a schematic front view showing a connecting side of the photonic component 12 (the coupling structure 12c) and a connecting side of the optical communication unit 13 (in other words, FIG. 4 shows a connection interface between the photonic component 12/the coupling structure 12c and the optical communication unit 13). In an embodiment, the coupling structure 12c has a first optical coupling surface 120c on a side corresponding to the optical communication unit 13, and first alignment structures 12a are disposed on the first optical coupling surface 120c. Conversely, the optical communication unit 13 has a second optical coupling surface 130 on a side corresponding to the coupling structure 12c, and second alignment structures 13a are disposed on the second optical coupling surface 130. The first alignment structures 12a and the second alignment structures 13a are, for example, complementary concave-convex structures, such that the coupling structure 12c and the optical communication unit 13 can be effectively connected via the mutual engagement of the first alignment structures 12a and the second alignment structures 13a.

In an embodiment, the photonic component 12 has coupling elements 121 such as couplers. The coupling elements 121 are exposed from a side surface of the photonic component 12. The coupling elements 121 are connected to first lenses 122, respectively (for example, each of the coupling elements 121 is individually connected to a corresponding first lens 122). The coupling structure 12c covers the side surface of the photonic component 12 as well as the first lenses 122. Conversely, each of the optical fibers 14 of the optical communication unit 13 is provided with a second lens 142 at an end corresponding to the photonic component 12. In addition, the first alignment structures 12a and the second alignment structures 13a (complementary concave-convex structures) become smaller and more refined the nearer the first alignment structures 12a and the second alignment structures 13a are to the second lenses 142 (for example, the first alignment structures 12a and the second alignment structures 13a become smaller in size and more refined as the first alignment structures 12a and the second alignment structures 13a are located close to the second lenses 142). Once the concave-convex structures near the second lenses 142 are aligned, the second lenses 142 on the side of the optical communication unit 13 can be precisely aligned with the first lenses 122 on the side of the photonic component 12.

In summary, the electronic package according to the present disclosure primarily features first alignment structures disposed on the first optical coupling surface of the photonic component, and second alignment structures disposed on the second optical coupling surface of the optical communication unit. This arrangement enables precise docking between the photonic component and the optical communication unit, thereby resolving the conventional misalignment issue that causes signal loss, and further enhancing the performance of silicon photonic transmission.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. An electronic package, comprising:
a carrier structure;
a photonic component disposed on the carrier structure; and
an optical communication unit connected to the photonic component, wherein the photonic component has a first optical coupling surface on a side corresponding to the optical communication unit, first alignment structures are disposed on the first optical coupling surface, the optical communication unit has a second optical coupling surface on a side corresponding to the photonic component, second alignment structures are disposed on the second optical coupling surface, and the photonic component and the optical communication unit are connected to each other via the first alignment structures and the second alignment structures.

2. The electronic package of claim 1, further comprising: an electronic component disposed on the carrier structure.

3. The electronic package of claim 2, wherein the electronic component is an electronic integrated circuit chip.

4. The electronic package of claim 1, wherein the photonic component is a photonic integrated circuit chip.

5. The electronic package of claim 1, wherein the optical communication unit is a fiber array unit connected to the photonic component and accommodates optical fibers.

6. The electronic package of claim 1, wherein the first alignment structures and the second alignment structures are complementary concave-convex structures.

7. The electronic package of claim 6, wherein the concave-convex structures are staggered and interlocked on the first optical coupling surface and the second optical coupling surface.

8. The electronic package of claim 1, further comprising: an encapsulation layer formed on the carrier structure and encapsulating the photonic component.

9. The electronic package of claim 1, wherein the photonic component is connected to the optical communication unit via a coupling structure.

10. The electronic package of claim 9, wherein the coupling structure is a light-transmissive structure.

11. The electronic package of claim 9, wherein the coupling structure has a refractive index corresponding to both the photonic component and the optical communication unit.

12. The electronic package of claim 9, wherein the coupling structure has the first optical coupling surface on a side corresponding to the optical communication unit.

13. The electronic package of claim 1, wherein the photonic component has coupling elements, and the coupling elements are exposed from a side surface of the photonic component and are respectively connected to first lenses.

14. The electronic package of claim 13, wherein each of optical fibers of the optical communication unit is provided with a second lens at an end corresponding to the photonic component.

15. The electronic package of claim 14, wherein the first alignment structures and the second alignment structures become smaller in size the nearer the first alignment structures and the second alignment structures are to the second lenses.
